(19) United States
(12) Patent Application Publication
(10) Pub. No.: US 2012/0286718 A1
(43) Pub. Date: Nov. 15, 2012

(54) SYSTEMS AND METHODS FOR PROVIDING A PERSONAL ELECTRONICS CARRYING DEVICE

(76) Inventor: David Richards, Orem, UT (US)

(21) Appl. No.: 13/421,846

(22) Filed: Mar. 15, 2012

Related U.S. Application Data
(60) Provisional application No. 61/453,055, filed on Mar. 15, 2011.

(51) Int. Cl. H02J 7/00

(52) U.S. Cl. 320/103

(57) ABSTRACT

The present invention relates to a device for carrying a personal electronic device. In particular, the present invention relates to a carrying device having an internal battery whereby a personal electronic device is coupled to the battery of the carrying device to power and/or charge the personal electronic device. Additionally, a carrying device is disclosed including an AC power adapter whereby the carrying device is plugged into an electrical receptacle to charge the battery of the carrying device.

### RELATED APPLICATIONS

This claims priority to U.S. Provisional Patent Application Ser. No. 61/453,055, filed Mar. 15, 2011, which is expressly incorporated herein by reference in its entirety.

### BACKGROUND OF THE INVENTION

1. Field of the Invention

The present disclosure relates generally to systems and methods for carrying personal electronic devices. In particular, at least some embodiments of the present invention relate to a backpack configured for use in conjunction with a variety of personal electronic devices.

2. Background and Related Art

In recent years, handheld devices have become common place and well integrated into every aspect of life. In particular, features such as multimedia, web browsing, electronic mail and telecommunications have become increasingly accessible and mobile. The mobility of these personal electronic devices is made possible due to batteries located within each electronic device. Batteries are generally provided with a limited capacity thereby requiring a user to charge the personal electronic device often. For some electronic devices, continual use of the electronic device requires that the electronic device be constantly plugged into an AC outlet, or be charged frequently throughout the day.

For example, a fully charged laptop computer battery may have a battery life of about 4 to 6 hours, thereafter requiring charging. Similarly, a G3 iPhone® may have a battery life of less than 6 hours. Thus, a user is greatly limited in the amount of time they can use the personal electronic device before the device must be charged. Current methods for mobile charging of personal electronic devices include use of additional, pre-charged batteries, including various piggyback batteries, as well as solar chargers, and the like. However, each of these current solutions is generally manufactured for a specific device and is an additional piece of equipment which the user must transport for use when needed.

Thus, while various systems and devices currently exist for mobile charging of personal electronic devices, substantial challenges still exist. Accordingly, it would be an improvement in the art to augment or even replace current mobile charging systems or techniques with other systems and/or techniques.

### SUMMARY OF THE INVENTION

The present disclosure relates generally to systems and methods for carrying personal electronic devices. In particular, at least some embodiments of the present invention relate to a backpack configured for use in conjunction with a variety of personal electronic devices.

In some aspects of the present invention, a personal electronics carrying device is provided having a plurality of compartments for carrying personal electronics as well as other personal items. The body generally includes a strap or handle whereby a user may carry the carrying device.

In some embodiments, the carrying device further includes a battery. The battery is generally disposed within a compartment of the body, and is provided to charge or power a personal electronic device used in combination with the carrying device. The carrying device may further include a battery indicator to alert a user to the status of the battery. In some embodiments, the carrying device further includes an AC power adapter whereby the carrying device is plugged into an AC wall receptacle to charge the battery of the carrying device.

The carrying device further includes a plurality of circuits that interconnects the battery, the battery indicator, the AC adapter, and a personal electronic device. In some embodiments, the carrying device further includes a plurality of inputs for coupling the personal electronic device to the battery via the plurality of circuits. The plurality of inputs includes both internal and external inputs whereby a user may couple a personal electronic device located within or without the carrying device.

In some embodiments, the carrying device further includes a GPS tracking device. The tracking device is a GPS transmitter that emits a signal that may be located by a GPS receiver, or a personal electronic device having hardware and/or software applications compatible with locating the tracking device. In some embodiments, the tracking device is discretely hidden within a lining of the body, such that the tracking device is unable to be removed from the carrying device. In other embodiments, the tracking device is registered with a tracking agency, such that the tracking device may be located in the event that the carrying device is stolen or otherwise lost.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a perspective view of a carrying device in accordance with a representative embodiment of the present invention;

FIG. 2 is a cross-sectional side view of a carrying device in accordance with a representative embodiment of the present invention;

FIG. 3A is a perspective view of a carrying device in accordance with a representative embodiment of the present invention;

FIG. 3B is a perspective view of a carrying device in accordance with a representative embodiment of the present invention;

FIG. 3C is a perspective view of a carrying device in accordance with a representative embodiment of the present invention;

FIG. 3D is a perspective view of a carrying device in accordance with a representative embodiment of the present invention;

FIG. 3E is a perspective view of a carrying device in accordance with a representative embodiment of the present invention;

FIG. 4 is a perspective view of a carrying device in accordance with a representative embodiment of the present invention;

FIG. 5A is a perspective view of a carrying device in accordance with a representative embodiment of the present invention;

FIG. 5B is a perspective view of a carrying device in accordance with a representative embodiment of the present invention;

FIG. 6A is a perspective view of a carrying device in accordance with a representative embodiment of the present invention; and

FIG. 6B is a perspective view of a carrying device in accordance with a representative embodiment of the present invention.

### DETAILED DESCRIPTION OF THE INVENTION

The present disclosure relates generally to systems and methods for carrying personal electronic devices. In particular, at least some embodiments of the present invention relate to a backpack configured for use in conjunction with a variety of personal electronic devices.

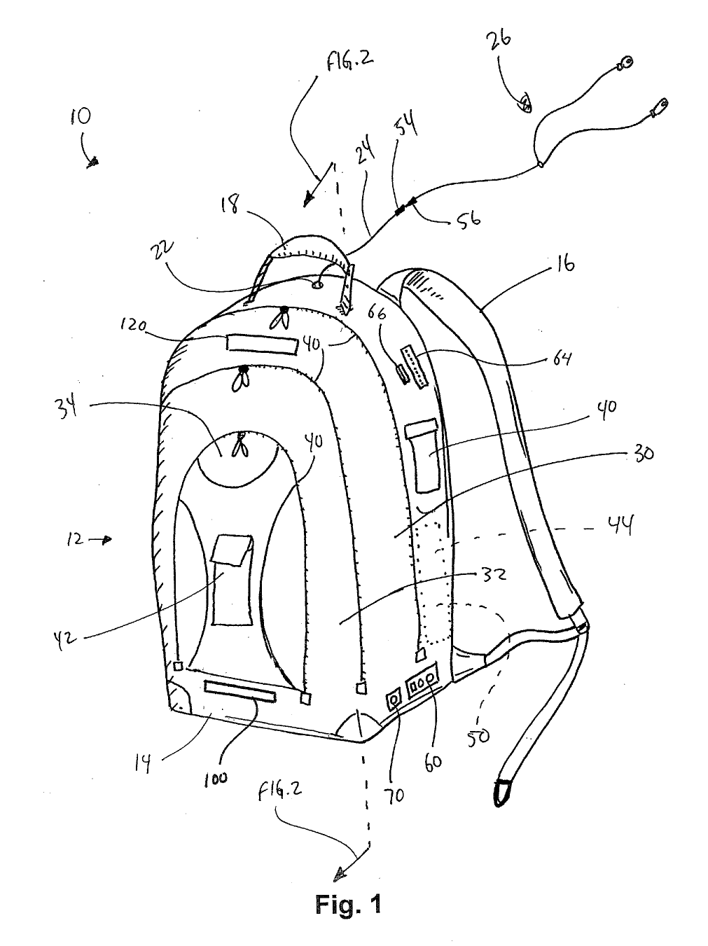

Referring to FIG. 1, a carrying device 10 is shown. A carrying device 10 in accordance with the present invention generally comprises any bag or portable container typically used to carry personal items. Non-limiting examples of portable containers include a backpack, a purse, a satchel, a sling, a handbag, a brief case, a diaper bag, a duffel bag, a suitcase, a piece of luggage, a piece of baggage, a trunk, a messenger bag, a computer bag, a fanny pack, an overnight bag, and a basket.

Some embodiments of the present invention comprise a portable container configured to carry a variety of personal items. For example, in some embodiments the carrying device 10 comprises a backpack 12. A backpack 12 in accordance with the present invention generally includes a body 14. The body 14 can be made in any of a variety of forms for carrying things, including personal electronic devices. In some embodiments, the backpack body 14 includes at least one shoulder strap 16 at the back side through which the backpack body 16 is carried on a user's back. In other embodiments, the carrying device 10 includes a handle or grip 18 in addition to and/or rather than a shoulder strap 16. For example, where the carrying device 10 comprises a brief case, the carrying device 10 may include only a handle 18. The carrying device 10 may further include padding 48 or other ergonomic designs and features to optimize use of the device 10.

In some embodiments, the body 14 further comprises a plurality of compartments 30, 32 and 34. An interior of each compartment 30, 32 and 34 is generally accessible via a zipper 40 or other closure device, as known in the art. Each compartment is separated from an adjacent compartment by a divider, such that each compartment may contain items separately from an adjacent compartment. For example, in some embodiment a first compartment 30 is configured to store a personal electronic device, while a second compartment 32 and a third compartment 34 are configured to hold other personal items. In other embodiments, a single compartment 30 is provided. The body 14 may further include pockets 40 and 42 disposed on the outside of the body 14 at a suitable location, as well as internally disposed pockets as needed. For example, in some embodiments an internally disposed pocket 44 is provided to retain a battery, as discussed in detail below.

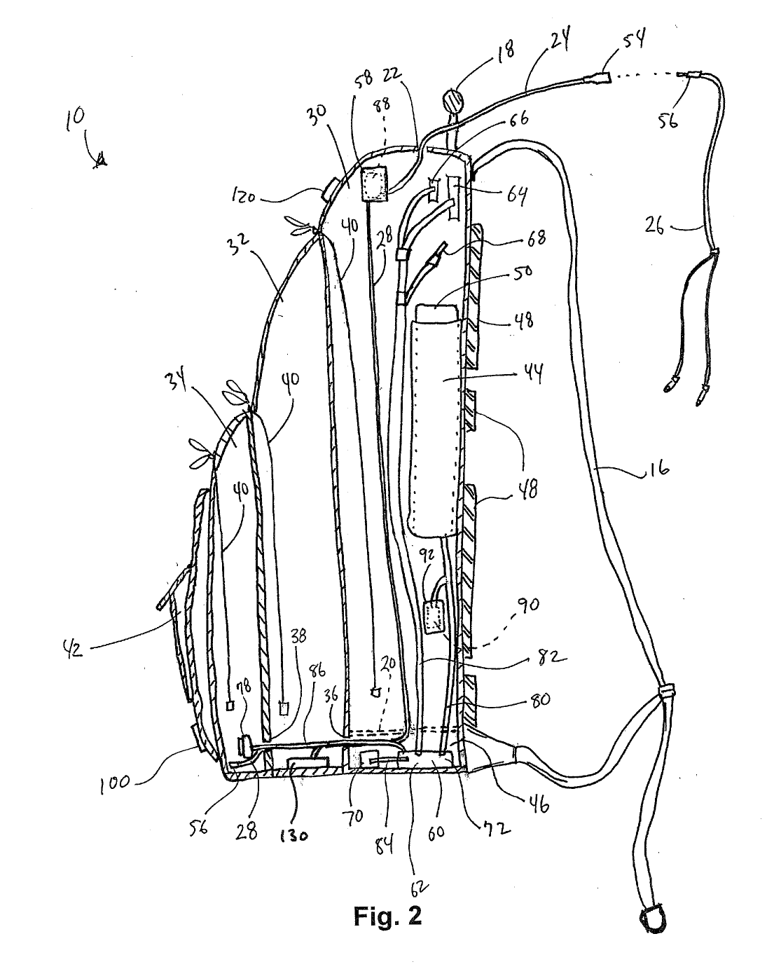

As previously discussed, some aspects of the present invention provide a carrying device 10 configured to carry a personal electronic device. A personal electronic device in accordance with the present invention may comprise any mobile electronic device, including but not limited to a cellphone device, a handheld device, an iPod® device, an iPhone® device, a computer, a personal digital assistant, a smartphone, a portable media player, a handheld game console, a personal navigation device, a digital compass, a calculator, an e-book reader, a pager, a digital video camera, and a digital still camera. The carrying device 10 of the present invention is designed to not only carry a personal electronic device, but is also designed to provide features useful in using a personal electronic device. For example, in some embodiments of the present invention the carrying device 10 further comprises a battery 50 for integrated use with a personal electronic device. In particular, for some embodiments a battery 50 is provided so that a user may charge, recharge or power a personal electronic device that is being carried in the carrying device 10. Some embodiments of the present invention include internal inputs (see FIG. 2) whereby a user may connect the personal electronic device to the battery 50. In other embodiments, a plurality of internal inputs is provided whereby a user may simultaneously connect a plurality of personal electronic devices to the battery 50.

Alternatively, for some embodiments a battery 50 is provided so that a user may charge, recharge or power a personal electronic device that is located externally to the carrying device 10. As such, some embodiments of the present invention include external inputs 64 and 66 whereby a user may connect the externally located personal electronic device to the internally located battery 50. External inputs 64 and 66 may include any I/O interface compatible with any personal electronic device described above. For example, in some embodiments the external input 64 comprises a 30-pin power connector for use with Apple® products. In other embodiments, external input 66 comprises a USB or mini USB power connector. However, one of skill in the art will appreciate that changes in technology may require an I/O interface not included in the personal electronic devices listed above. As such, external inputs 64 and 66 may be modified to compatibly receive any personal electronic device known and/or used in the art.

Additional features of the present invention may include an external battery indicator 60. The battery indicator 60 provides visual feedback regarding the status of the internally disposed battery 50. The battery indicator generally comprises various LED lights to indicate a power level of the battery. For example, in some embodiments a green light indicates a full battery charge, an amber light indicates a moderate battery charge, and a red light indicates a low battery charge. In other embodiments, the battery indicator 60 comprises various LED lights to indicate an event associated with the battery. For example, in some embodiments a flashing amber light indicates that the battery 50 is being charged. In other embodiments, a flashing green light indicates that the battery 50 is full, and no longer charging. Further, in some embodiments a red flashing light indicates that the power level of the battery is too low to power the electronic device, thereby signaling to the user the need to charge the battery 50.

The body 14 further includes an external AC power adaptor 70. The power adaptor 70 is configured to receive a cord whereby the carrying device 10 is plugged into an electrical receptacle. Once plugged in, the power adaptor 70 permits the internal battery 50 to be recharged. Alternatively, in some embodiments the AC power adaptor 70 is coupled to an electrical receptacle to directly power a personal electronic device being used in conjunction with the carrying device 10. In other embodiments, the AC power adaptor 70 permits simultaneous recharging of the battery 50 and a personal electronic device.

In some embodiments, body 14 further includes a DC socket whereby carrying device 10 may be coupled to a DC source, such as a car, airplane, or boat. In other embodiments, body 14 comprises a DC adapter cord that is plugged into the DC outlet or socket of a car, plane, boat and/or train. In other embodiment, body 14 comprises at least one of a DC cord or a DC socket whereby carrying device 10 is coupled to a DC source, such as an external battery.

The body 14 further includes a hole 22 through which an audio cord 24 passes from the interior of the body 14 to the exterior. The audio cord 24 may include any mono or stereo cable configured to receive a set of headphones 26 for use with a personal electronic device. For example, in some embodiments the audio cord 24 comprises a 3.5 mm female audio jack 54 configured to receive a 3.5 mm male probe of the headphones 26. An internally disposed portion of the audio cord 24 is provided such that the personal electronic device may be coupled thereto. As such, a user may listen to a personal electronic device, such as an Ipod®, carried within a compartment 30, 32 or 34 of the body 14. In some embodiment, a personal electronic device is both charged and externally accessed via headphones while being carried within a compartment 30, 32 or 34 of the body 14.

Referring now to FIG. 2, a cross-sectioned view of a carrying device 10 is shown. The carrying device 10 comprises a plurality of circuits by which the various electrical components of the device 10 are interconnected. Among these circuits is a main circuit 80 which interconnects the battery 50 and the battery indicator 60. Other circuits include an accessory power circuit 82 which interconnects the battery indicator 60 and the external inputs 64 and 66. In other embodiments, the accessory power circuit 82 further interconnects the battery indicator 60 and an internally disposed input 68. The internal input 68 enables a personal electronic device, such as a laptop computer, to be carried within the body 14 of the carrying device 10 while coupled to the battery 50. The carrying device 10 further includes an AC circuit 84 which interconnects the AC adaptor 70 and the battery indicator 60. Further, the carrying device 10 includes an auxiliary input circuit 86 which interconnects a second internal input 78 and the battery indicator 60. One of skill in the art will appreciate that the carrying device 10 may be modified to include additional circuits as needed to enable additional uses of the carrying device 10, in accordance with the present invention. For example, in some embodiments the carrying device 10 further includes a photovoltaic cell 120 disposed on an outer surface of the body 14, whereby a circuit (not shown) is provided between the photovoltaic cell and the battery indicator 60 to charge the battery 50 and/or power a personal electronic device. In other embodiments, the carrying device 10 further comprises a kinetic generator 130 configured to convert the daily motions of the user into electricity sufficient to charge the battery 50. The kinetic generator 130 may comprise a dynamo generator, a linear generator, a swinging pendulum generator, and/or an electrostatic generator used to either power an electrical component (not shown), charge a battery 50 and/or charge a capacitor or supercapacitor (not shown).

The circuits 80, 82, 84 and 86 are generally hidden within an outer wall or a lining layer (not shown) of the body 14. As such, the circuits 80, 82, 84 and 86 do not interfere with the storage capacity of the respective compartment 30, 32 and/or 34. In some embodiments, the body 14 further includes a false bottom 20. The false bottom 20 is positioned within a lower portion of a respective chamber 30, 32 and/or 34 to provide a hidden compartment 46 for housing the battery indicator 60 and the AC adapter 70. In other embodiments, the hidden compartment 46 comprises a pouch or a portion of the body lining in which the battery indicator 60 and the AC adapter 70 are stored. Thus, any compartment 30, 32 and 34 may be configured to carry a personal electronic device without having the personal electronic device contact and/or damage the various components and circuits 60, 70, 80, 82, 84 and 86 of the carrying device 10.

In some embodiments, the battery indicator 60 further comprises an AC/DC transformer 62. The AC/DC transformer 62 enables the battery 50 to be both charged via the AC power adaptor 70, and pass voltage from the battery 50 to personal electronic devices via the accessory power circuit 82. In some embodiments, the accessory power circuit 82 further includes a plurality of resistors (not shown) whereby a voltage delivered to the respective input 64, 66 and 68 is reduced as required by personal electronic device attached thereto. In other embodiments, the AC/DC transformer 62 further comprises a selector switch (not shown) by which the user may select a voltage delivered to an attached personal electronic device.

The AC/DC transformer 62 may be configured to enable simultaneous charging of the battery 50 and powering of the personal electronic device(s) via the AC adaptor 70. For example, in some embodiments the AC/DC transformer 62 further comprises a DC-Output Uninterruptible Power Supply (DC UPS 72). The DC UPS 72 enables the battery to be charged via the AC adaptor 70, and the battery 50 to directly and simultaneously charge/power the personal electronic devices coupled to their respective circuits 82 and 86. Thus, the DC UPS 72 acts as a rectifier to convert the alternating current from the AC adaptor 70 to direct current to charge the battery 50. The DC UPS 72 further comprises circuitry to permit the charging battery 50 to simultaneously output voltage to the personal electronic device(s) coupled to their respective circuits 82 and 86. In some embodiments, the DC UPS 72 further comprises a variable voltage output switch (not shown) by which the user may select a desired voltage output from the battery 50 to the personal electronic device(s).

The battery 50, battery indicator 60 and AC adaptor 70 are generally positioned in proximity to one another within a compartment 30, 32 and 34 of the backpack body 14. In some embodiments, access holes 36 and 38 are provided between compartments 30 and 32, and compartments 32 and 34. In some embodiments, the access holes 36 and 38 permit various components 50, 60 and 70 of the carrying device 10 to be positioned separately in adjacent compartments 30, 32 and 34. In other embodiments, the access holes 36 and 38 permit the internal input 78 to be disposed either in the first compartment 30, the second compartment 32, or the third compartment 34, as desired. Thus, a user may connect a personal electronic device to the input 78 and carry the electronic device in any of the compartments 30, 32 and 34.

In some embodiments, an audio extension cord 28 is provided within the body 14 of the carrying device 10. The audio extension cord 28 is generally provided to permit a user to externally access a personal electronic device stored within a compartment 30, 32 and/or 34 of the body 14. The extension cord 28 comprises an audio cable having a male probe 56 configured to couple a female jack of a personal electronic device. In some embodiments, the extension cord 28 is routed through the various access holes 36 and/or 38 to enable coupling of a personal electronic device stored in the second or third compartments 32 or 34. In other embodiments, a personal electronic device is simultaneously coupled to the internal input 78 and the extension cord 28.

In some embodiments, the extension cord 28 and the audio cord 24 comprise a single cord. In other embodiments, a cord coiler 58 is interposed between the audio cord 24 and the extension cord 28. The cord coiler 58 is generally attached to an interior surface of the body 14 approximate to the access hole 22. In some embodiments, the cord coiler 58 is disposed within a pouch, a pocket, or within a wall of the body 14, so as to be concealed. The cord coiler 58 generally comprises an outer case containing a reel 88 onto which the audio cord 24 is wound. The cord coiler 58 further comprises a spring (not shown) that becomes loaded as the cord 24 is unwound from the reel 88. In some embodiments, the cord coiler 58 further comprises a ratchet and pawl (not shown) whereby an unwound position of the cord 24 is maintained. Following use of the cord 24, the pawl is released and the spring recoils the cord 24 onto the reel 88 within the case of the cord coiler 58. In some embodiments, an external pocket (not shown) is provided adjacent to the access hole 22 for storage of the headphones 26 when not in use.

Further, some embodiments of the present invention further include a tracking device 90. The tracking device 90 generally comprises a global positioning satellite (GPS) transmitter that sends or “pushes” data, at regular intervals, to a server that analyzes the pushed data to determine the position of the tracking device 90. A GPS receiver is then used to guide a user to the position of the tracking device 90 and the misplaced carrying device 10. In some embodiments, the GPS transmitter is powered by the battery 50 via the main circuit 80. In other embodiments, the tracking device 90 contains a separate battery (not shown) that is charged by the battery 50 via the main circuit 80. As such, in the event that the carrying device battery 50 runs out of power, the battery of the tracking device 90 is available to power the tracking device 90. In some embodiments, the tracking device 90 is concealed within a secret pocket 92, pouch or lining of the body 14 to prevent intentional removal of the tracking device 90 from the carrying device 10.

In some embodiments, the tracking device 90 is first registered with an independent tracking service. The tracking service may be included in a world-wide protection plan that is offered for purchase in addition to the purchase price of the carrying device 10. Following registration of the tracking device 90, the independent tracking service may then track the tracking device 90 to determine the location of the carrying device 10 in the event that the carrying device 10 becomes lost or stolen. In other embodiments, the tracking device 90 is located via a personal electronic device, such as a GPS receiver or an iPhone, whereby the location of the carrying device 10 is determined using hardware and/or a software application contained in the personal electronic device. Thus, in the event that the carrying device 10 becomes lost or stolen, a user may locate the device 10 with a personal electronic device that is not currently being stored in the carrying device 10.

The carrying device 10 may further include a registered identification tag 100. The identification tag 100 is generally positioned on an outer surface of the body 14 so as to be easily identified and read by a user. In some embodiments, the identification tag 100 is registered with an international registry whereby a number, name or code on the identification tag 100 is registered to a name or contact information of the carrying device's owner. Thus, in the event that the carrying device 10 becomes lost or stolen, a finder of the carrying device 10 may locate and/or contact the owner of the carrying device 10 via the information obtained from the international registry using the number, name or code on the identification tag 100.

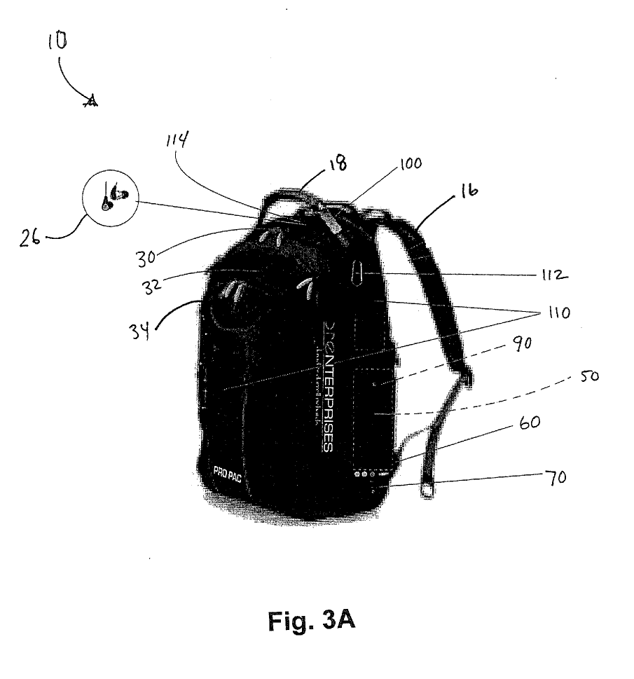

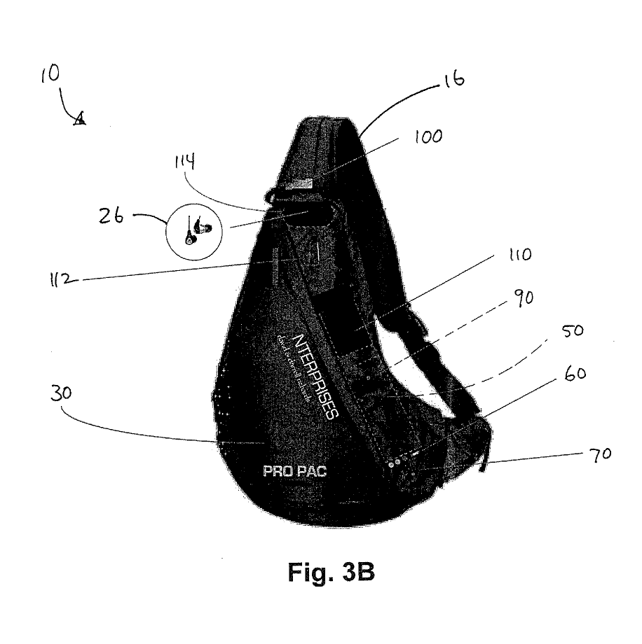

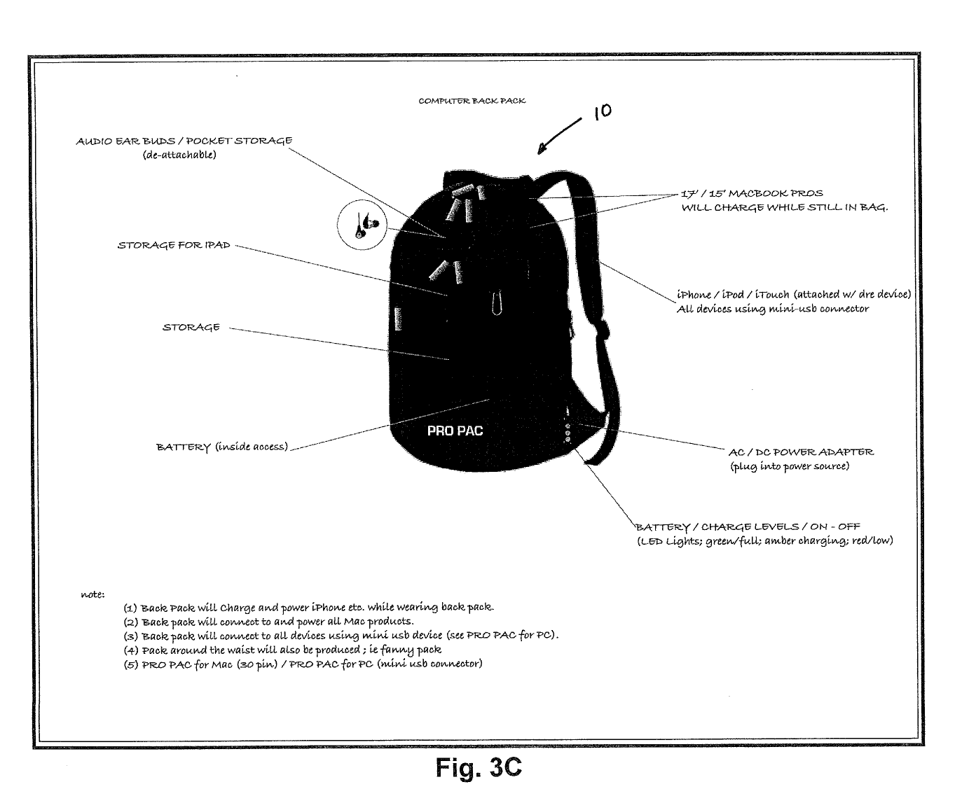

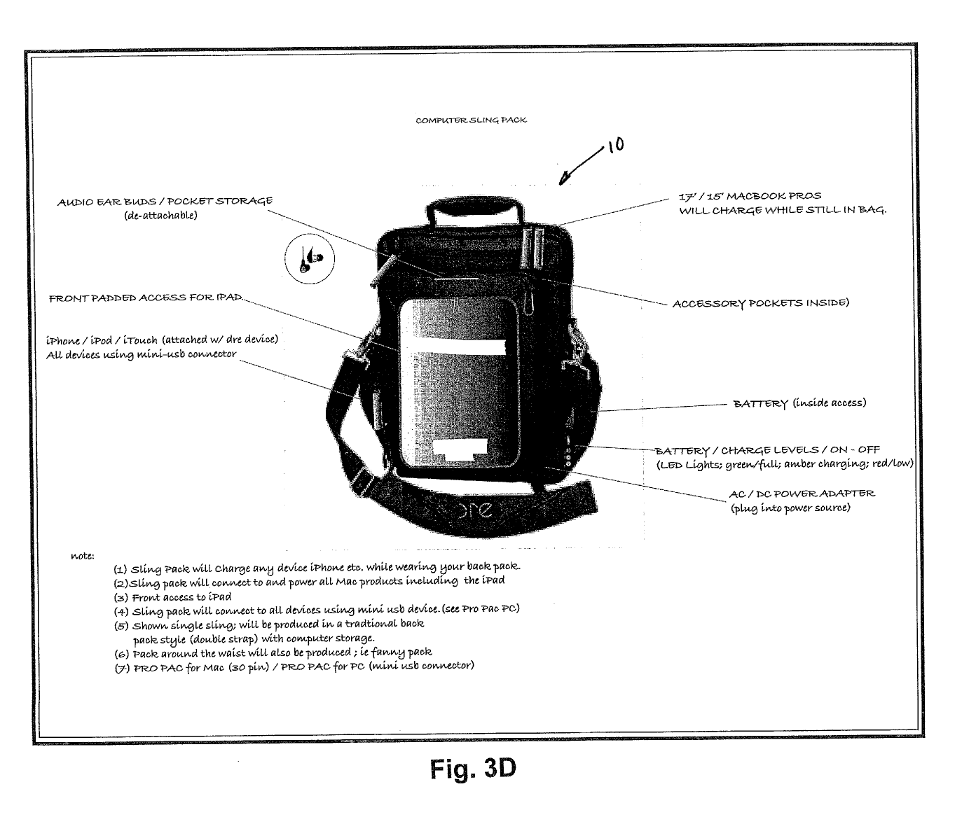

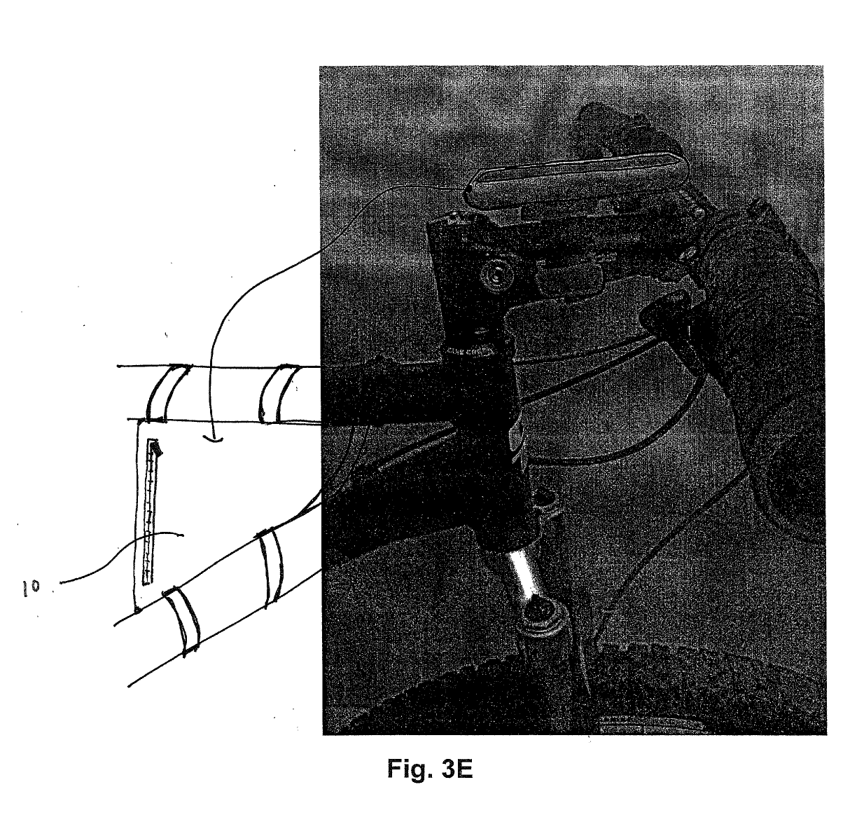

Referring generally to FIGS. 3A-3E, various embodiments of a carrying device 10 are shown. Some embodiments of the present invention include a carrying device comprising a backpack, a sling, a messenger bag, a hip pack, a golf bag, and a bicycle bag. A carrying device 10 in accordance with the present invention may be configured to compatibly carry a PC or MAC based personal electronic device, such as a laptop, a media player, an iPhone®, a media player, and a smartphone. In some embodiments, carrying device 10 comprises a power source, such as a battery, to power a remotely located electronic device, such as a media player or mobile phone, as shown in FIG. 3E. Additional features of the carrying device may include accessory pockets 110, key ring 112, and a pocket 114 for storing head phones or ear phones 26. In some embodiments, the earphone 26 is configured to be detachable from the carrying device 10. In other embodiments, carrying device 10 comprises a waterproof or water resistant material whereby a personal electronic device contained within the carrying device 10 is protected from exposure to moisture.

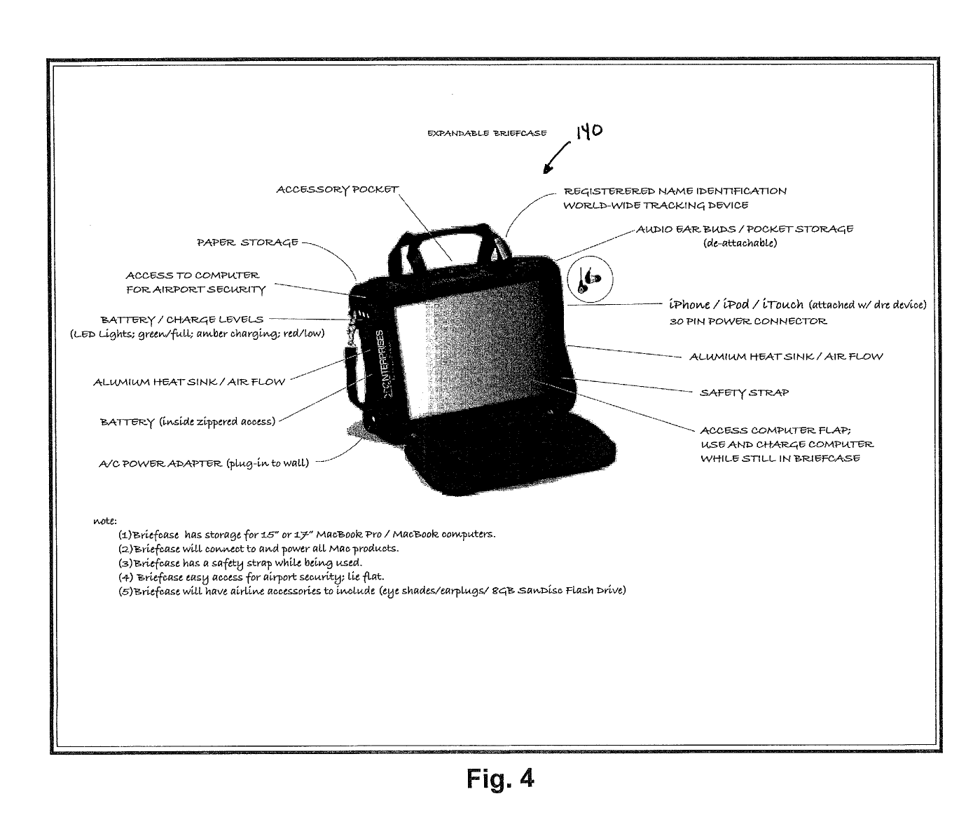

Referring now to FIG. 4, an expandable brief case 140 is shown. Some embodiments of expandable brief case 140 comprise selected features of carrying device 10, as disclosed above. In other embodiments, expandable brief case 140 further comprises features to enable use of a laptop while the laptop is stored in the case. For example, some embodiments include heat sink and air flow capacities to reduce and/or dissipate heat generated by the laptop. Briefcase 140 further comprises the ability to unfold into a prone configuration such that the laptop is laid flat, in a prone position. This feature permits the laptop to be passed through a x-ray scanning device without requiring removal of the laptop from briefcase 140. Further, in some embodiments briefcase 140 comprises an opening whereby the user may access and use the laptop without removing the laptop from briefcase 140. This feature allows the user to place the briefcase 140 on their lap or another surface whereby the opening is accessible to the use and the heat sink and/or air flow features and interposed between the laptop and the user's lap or desired surface.

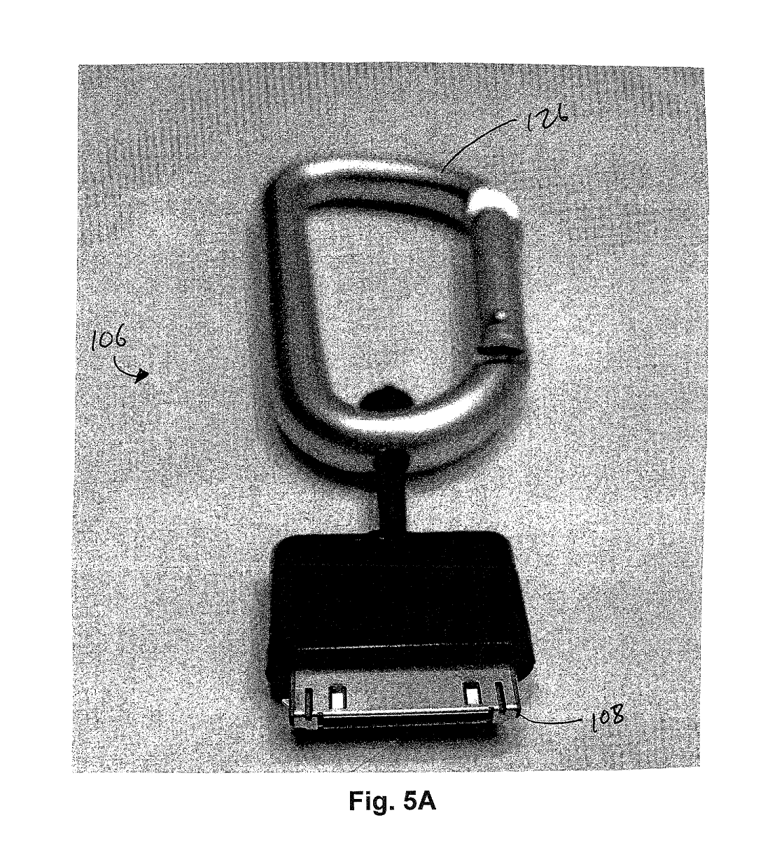

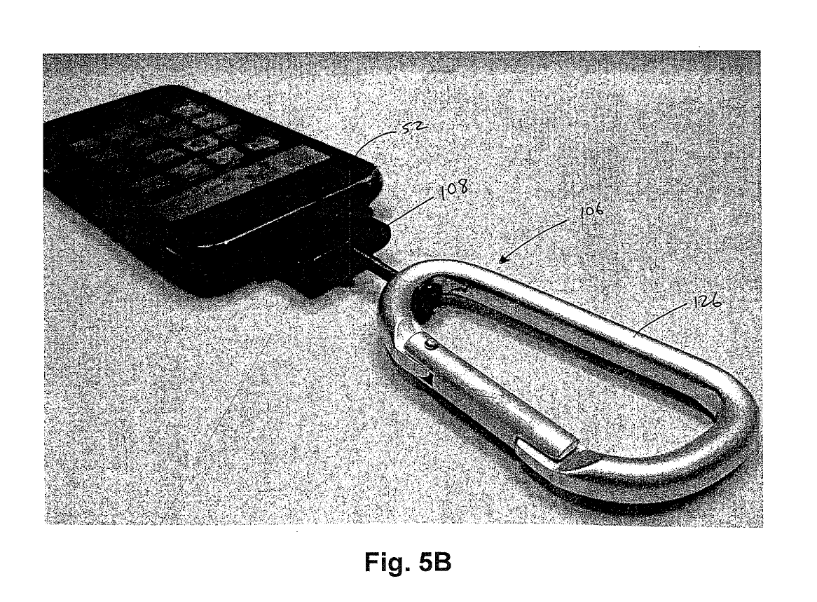

Referring now to FIG. 5A a carrying device 106 is shown. Some embodiments of carrying device 106 comprise a mechanical coupler 108 fixedly coupled to an attachment device 126. Coupler 108 is generally configured to compatibly receive or compatibly insert within a preferred personal electronic device 52, such as a mobile phone, as shown in FIG. 5B. Attachment device 126 may include any structure or mechanism to enable connection of device 52 to a desired surface or object. For example, in some embodiments attachment device 126 is a carabineer.

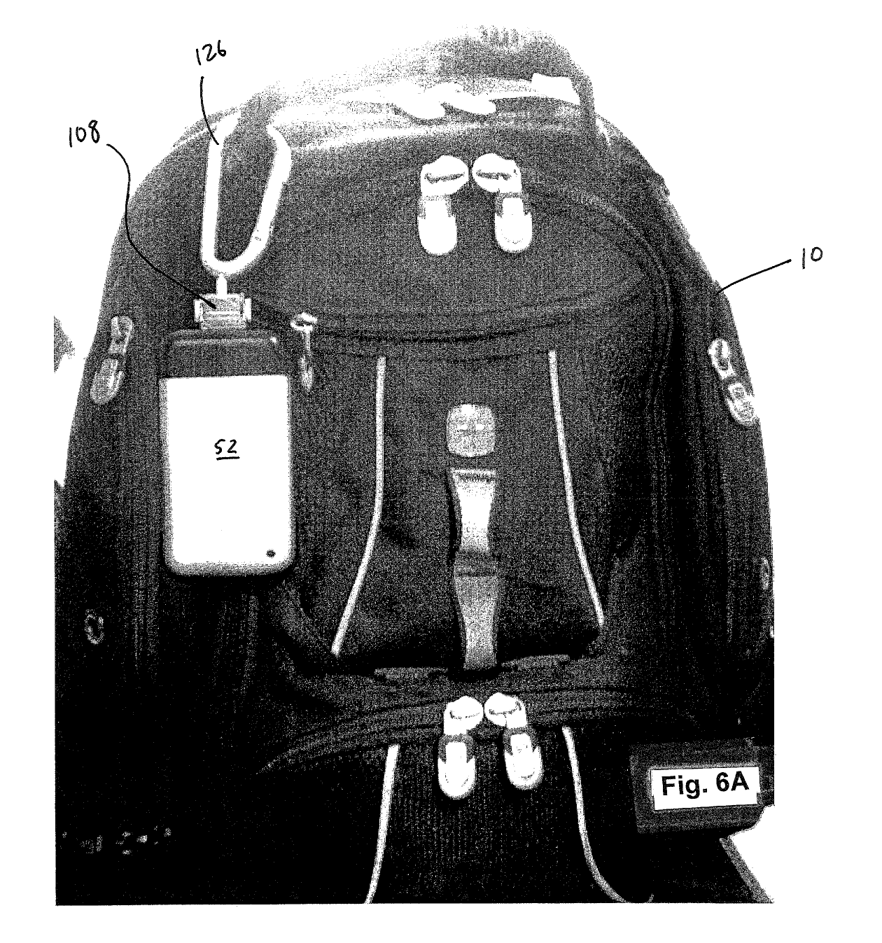

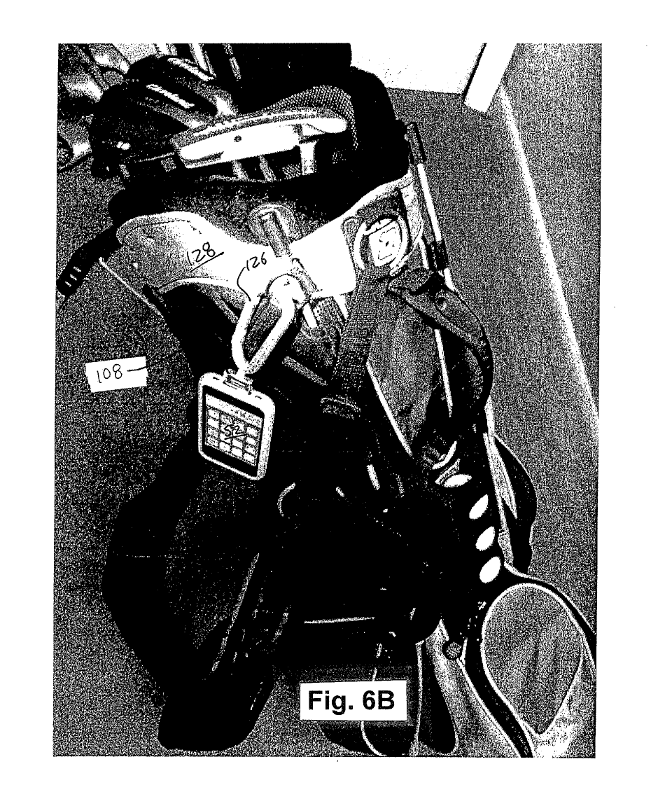

Referring now to FIG. 6A, an electronic device 52 is attached to a backpack carrying device 10 via the attachment device 126 of carrying device 106. Similarly, FIG. 6B shows an electronic device 52 coupled to a golf bag 128 via attachment device 126 of carrying device 106.

Thus, as discussed herein, the embodiments of the present invention generally relate to a device for carrying a personal electronic device. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A carrying device for use in combination with a personal electronic device, the carrying device comprising:
a body having a compartment for holding the personal electronic device;
a battery attached to a surface of the body, the battery further being coupled to the personal electronic device;
an input interposed between the battery and the personal electronic device; and
a circuitry interposed between the input and the battery, wherein the battery powers and charges the personal electronic device.
